(19) United States
(12) Patent Application Publication
(10) Pub. No.: US 2004/0124382 A1
(43) Pub. Date: Jul. 1, 2004

(54) Fluid control servo-solenoid valve with self-contained actuating fluid

(75) Inventor: Gerd Berger, Dusseldorf (DE)

Correspondence Address: ROBERT W. BECKER & ASSOCIATES, Suite B, 707 Highway 66 East, Tijeras, NM, 87059, US

(73) Assignee: A.u.K. Muller GmbH & Co. KG, Dusseldorf (DE)

(21) Appl. No.: 10/735,444

(22) Filed: Dec. 12, 2003

(30) Foreign Application Priority Data
Dec. 13, 2001 (DE) 202 19 358.6

(51) Int. Cl. F16K 31/12

(52) U.S. Cl. 251/30.02

(57) ABSTRACT

A fluid control servo-solenoid valve with self-contained actuating fluid includes a housing configured as a small, elongate body having a pair of lengthwise sides and a pair of widthwise sides each relatively shorter than either of the lengthwise sides, whereby the valve inlet and the valve outlet are each disposed on a respective one of the widthwise outer sides of the housing and the inlet/outlet flow direction extends parallel to the housing longitudinal axis. The fluid control servo-solenoid valve with self-contained actuating fluid also includes a differential piston disposed in the housing such that its movement is perpendicular to the housing longitudinal axis. The pilot valve of the fluid control servo-solenoid valve with self-contained actuating fluid is dismountably secured on the respective smaller outer side of the housing on which the valve outlet is located.

### BACKGROUND OF THE INVENTION

The present invention relates to a fluid control servo-solenoid valve with self-contained actuating fluid, in particular, for sanitary installations, the fluid control servo-solenoid valve with self-contained actuating fluid comprising a valve housing having therein a valve inlet and a valve outlet which can be isolated from one another in a sealed manner via the seating of a valve flange in a valve closing position on a valve seat, whereby the valve inlet and the valve outlet are located on two opposed sides of the valve housing, and the fluid control servo-solenoid valve with self-contained actuating fluid further comprising a displaceable differential piston, disposed in the valve housing, that supports thereon the valve flange, wherein, on one side of the differential piston, there is a pressure volume communicated with the valve inlet and, additionally, selectively communicated via the valve seat with the valve outlet while, on the other side of the differential piston, there is a control volume that is selectively communicated with the valve outlet via a relief bore that is closable by means of a closure element associated with the plunger of an electromagnetic pilot valve, the control volume being communicated via a control channel with the pressure volume, and the pressure volume being sealed off relative to the control volume via a seal along the edge regions of the differential piston.

Valves having the afore-described features are conventionally known such as are disclosed, for example, in EP 0 936 317 Al and DE 29819 769.3 U.

In conventional valves of this type, pilot valves configured as electromagnetic valves are integrated into the valve housing, and the differential piston in a conventional arrangement of this type is disposed in the valve housing such that the movement of the differential piston is in a direction parallel to the inlet flow and outlet flow directions of the fluid medium.

As a result of the configuration of the just-described conventional arrangement, the pilot valve is not exchangeable without undertaking further measures and, moreover, the valve in its entirety must be configured relatively wide in its dimension transverse to the inlet and outlet flow directions. Since these valves are often configured as cartridge valves with a tapped or threaded section on the end of the valve housing for threaded securement of the valve in a valve receipt location, this valve receipt location must also be configured relatively wide. This leads to installation difficulties and, in particular, installation difficulties with respect to sanitary installations whereat the spatial relationships are often narrow.

### SUMMARY OF THE INVENTION

The present invention offers a solution to the challenge of configuring a fluid control servo-solenoid valve with self-contained actuating fluid having the above-noted features and being improved in that the valve in its entirety is of a small dimension, as a consequence of which its small width dimension takes up only relatively little space, and being further improved in that the pilot valve of the inventive valve is relatively easily exchanged into, or exchanged out of, the inventive fluid control servo-solenoid valve with self-contained actuating fluid.

In accordance with the present invention, the inventive fluid control servo-solenoid valve with self-contained actuating fluid is characterized by the combination of the following features:

a) the housing is configured as a small, elongate body having a pair of lengthwise sides and a pair of widthwise sides each relatively shorter than either of the lengthwise sides, whereby the valve inlet and the valve outlet are each disposed on a respective one of the widthwise outer sides of the housing and the inlet/outlet flow direction extends parallel to the housing longitudinal axis;

b) the differential piston is disposed in the housing such that its movement is perpendicular to the housing longitudinal axis;

c) the pilot valve is dismountably secured on the respective widthwise outer side of the housing on which the valve outlet is located; and

d) the relief bore is configured as a pilot valve seat, closable by a closure element, and located between the valve chamber of the pilot valve and an outflow channel communicated with the valve outlet, whereby the valve chamber is communicated via a balance channel with the control volume.

Advantageous configurations and modifications of the inventive valve are described in further detail hereinafter.

In accordance with one core concept of the present invention, the differential piston, which has the valve flange associated therewith, is disposed in the housing such that its movement is not parallel but, instead, perpendicular, to the flow-through direction. A further core concept of the present invention is that the pilot valve is configured such that the movement of the closure element communicated with the plunger is not, as is the case with conventional valves, parallel to the movement of the differential piston but is, instead, perpendicular to the direction of movement of the differential piston. In this connection, the pilot valve is dismountably secured to the respective outer side of the housing on which the valve outlet is located. Since the housing is configured as a small, elongate body, whose length is greater than its width, and the valve inlet and valve outlet are disposed on the pair of the relatively smaller widthwise outer sides of the housing, whereby the inlet/outlet flow direction extends parallel to the housing longitudinal axis, the inventive valve is, in its entirety, configured of a very small dimension. The inventive valve can be dimensioned so small that it can be integrated directly into the conduit leading to a sanitary installation. As is illustrated hereinafter in connection with the description of several embodiments of the inventive valve, the valve can be provided, on its valve inlet and/or valve outlet, with pipe or hose connections and, as well, the respective one of the widthwise sides of the valve on which the valve inlet is located can be provided with a threaded support, through which the valve inlet extends, for threaded securement of the valve in a valve receipt location.

### BRIEF DESCRIPTION OF THE DRAWINGS

Embodiments of the inventive valve of the present invention are described in more detail hereinafter with reference to the figures of the drawings.

FIG. 1 is an elevational sectional view of a fluid control servo-solenoid valve with self-contained actuating fluid showing a sectional view taken longitudinally along the longitudinal direction of the valve housing;

FIG. 2 is an elevational view in partial section of the one embodiment of the inventive valve shown in FIG. 1;

FIG. 3 is an elevational view of the one embodiment of the inventive valve of FIG. 1 and showing the valve at an orientation offset by 90 degrees with respect to the view of the valve shown in FIG. 2;

FIG. 4 is a perspective view of the one embodiment of the inventive valve shown in FIG. 1 and showing an installed pipe piece communicated with the valve outlet;

FIG. 5 is an exploded perspective view of the one embodiment of the inventive valve shown in FIG. 1;

FIG. 6 is an elevational sectional view of another embodiment of the inventive valve in the present invention; and

FIG. 7 is a perspective view of another embodiment of the inventive valve shown in FIG. 6 and showing pipe pieces communicated respectively with the valve inlet and the valve outlet.

### DETAILED DESCRIPTION OF THE PREFERRED EMBODIMENT

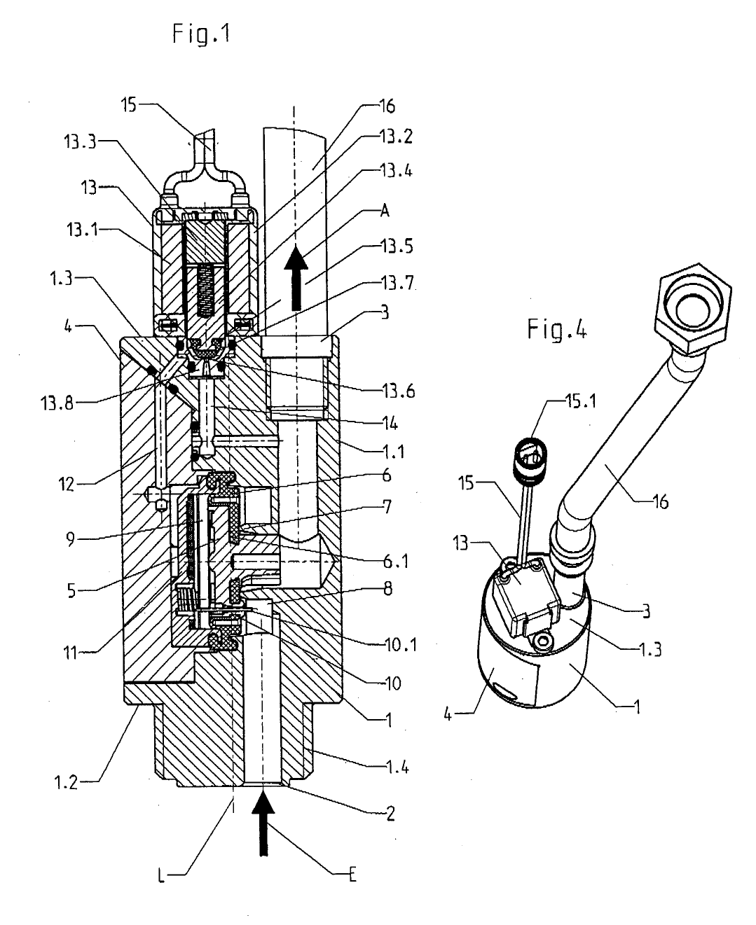

FIGS. 1-5 illustrate one embodiment of the inventive fluid control servo-solenoid valve with self-contained actuating fluid of the present invention. The inventive fluid control servo-solenoid valve with self-contained actuating fluid comprises a valve housing which is configured as a two-piece component and which includes a base body 1 having, on one side, an opening that provides access into the housing, the opening being covered by a housing cover 4 extending in the direction of the housing longitudinal axis L over a portion of the longitudinal extent of the housing. The entire housing is configured as a small, elongate, substantially cylindrical body having a sleeve surface 1.1 as well as two small end surfaces 1.2 and 1.3 disposed on its outer side. A valve inlet 2 is located in the region of one of the end surfaces 1.2 and the valve inlet extends through a tapped or threaded support 1.4 which serves for threaded securement of the valve in a valve receipt location.

A valve outlet 3 is disposed on the end surface 1.3 at an offset from the housing longitudinal axis L. Moreover, a pilot valve 13 is secured on this end surface, the pilot valve being described in more detail hereinafter.

A differential piston 5 is disposed in the interior space of the valve housing, the differential piston being displaceable in a direction perpendicular to the valve housing longitudinal axis L. A pressure volume 8 is located on one side of the differential piston, the pressure volume being communicated with the valve inlet 2 and being communicated via a valve seat 7 with the valve outlet 3 while a control volume 9 is located on the other side of the differential piston 5.

The pressure volume 8 is sealed off relative to the control volume 9 in the edge region of the differential piston 5 via a membrane 6 in which a valve flange 6.1 is integrated. The control volume 9 is communicated with the pressure volume 8 via a control channel which is configured as a control bore 10 extending through the differential piston 5 along a line eccentric or offset to the differential piston center. A cleaning spring 10.1 is provided to ensure continuous cleaning of this control bore 10.

The control volume 9 is, moreover, communicated with the valve outlet 3 via a relief bore which is selectively collapsible via a closure element. The relief bore is configured as a collapsible pilot valve seat 13.6 in the pilot valve 13 located between the valve chamber 13.7 of the pilot valve 13 and an outflow channel 14 communicated with the valve outlet 3. The valve chamber 13.7 is connected or communicated with the control volume 9 via a discharge channel 12.

The pilot valve 13, which is configured as an electromagnetic valve, comprises the conventional pilot valve components of a magnetic coil 13.1, a magnetic yoke 13.2, a head piece 13.3 connected to the magnetic yoke, and, as well, a moveable plunger 13.4. The plunger 13.4 has an end projecting out of the magnetic coil on which a pilot valve flange 13.5 is mounted with the pilot valve flange being in an arrangement in which it is in opposition to the pilot valve seat 13.6. The valve chamber 13.7 of the pilot valve 13 is located in a coupling piece 13.8, the coupling piece 13.8 with the pilot valve 13 therein being deployable in a corresponding opening on the end surface 1.3 of the base body 1. In the illustrated embodiment, a pipe piece 16 is shown in an installed position in which it communicates with the valve outlet 3. Electrical signals are conducted to the pilot valve 13 via connection leads 15 communicated with a plug 15.1.

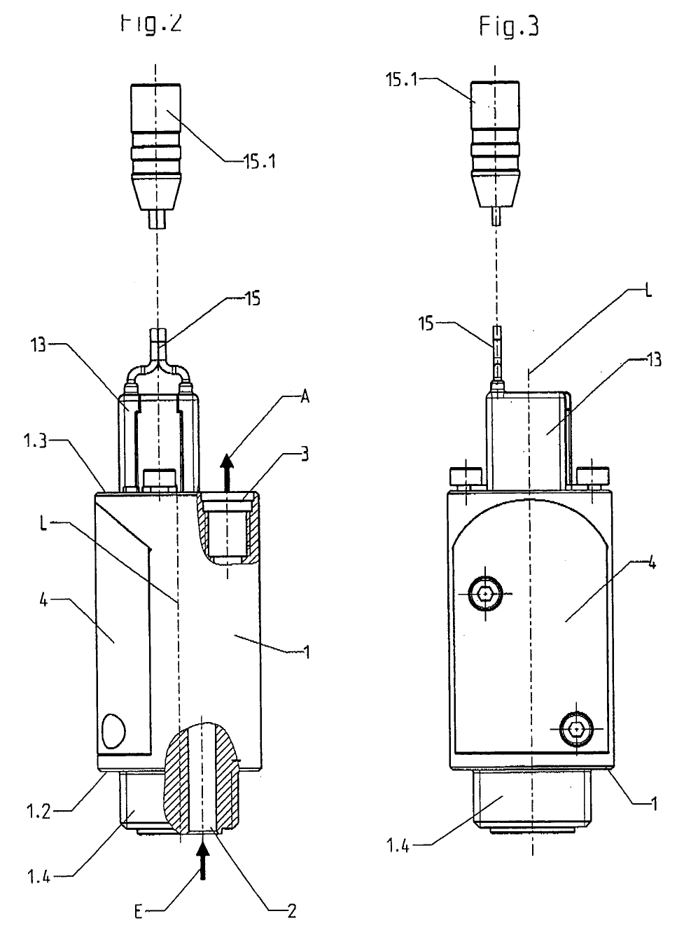

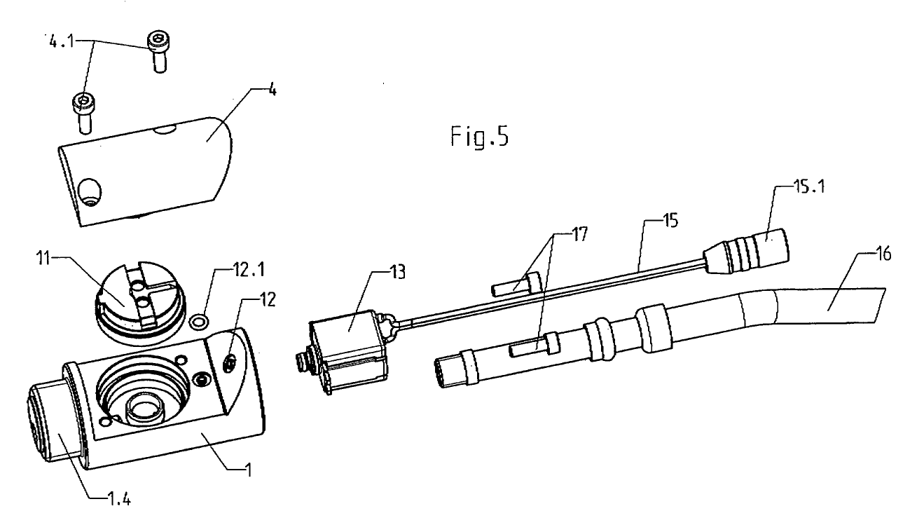

The pipe piece 16 is not shown in the respective views of the one embodiment of the inventive valve shown in FIGS. 2 and 3. FIG. 5 shows the one embodiment of the inventive valve in an exploded view thereof. The differential piston 5, the membrane 6, and a hood 11 which closes off the control volume 9 are configured as an integrally formed unitary component which can be inserted into the interior space of the base body 1 through the opening to be covered by the housing cover 4. Following installation of the unitary component of the differential piston 5, the membrane 6, and the hood 11 within the base body 1, the housing cover 4 is disposed onto the housing and is secured thereonto via threaded securement bolts 4.1. The portion of the discharge channel 12 defined by the border between the cover 4 and the base body 1 is sealed by means of a seal 12.1. The magnetic valve 13 is secured by means of threaded securement elements 17 onto the base body 1.

The operation of the one embodiment of the inventive valve shown in FIGS. 1-5 is as follows.

During the closed condition of the pilot valve 13, a pressurized condition obtains in the control volume 9, which, due to the communication of the control volume 9 with the valve inlet 2 via the control bore 10, maintains the membrane 6, with the therewith integrated valve flange 6.1, seated on the valve seat 7. Upon the transmission of an electrical signal to the magnetic coil 13.1 of the pilot valve, the plunger 13.4 retracts and the closure element 13.5 lifts off the pilot valve seat 13.6, which serves as the relief bore of the inventive fluid control servo-solenoid valve with self-contained actuating fluid. The pilot valve 13 is thus in an opened condition. This condition, in which the control volume 9 is now communicated with the valve outlet 3 via the discharge channel 12 and the outflow channel 14, leads to a diminishment of the pressure in the control volume 9. In connection therewith, the water pressure originating from the valve inlet 2 against the respective side of the membrane 6 turned toward the pressure volume 8 lifts the valve flange 6.1 off the valve seat 7. In further connection therewith, the fluid medium flows into the valve in the overall direction indicated by the arrow E from the valve inlet 2 to the valve outlet 3 and, from there, flows further in the direction of the arrow A via the pipe piece 16 to a not-illustrated fixture outlet. If the pilot valve 13 is again closed, a corresponding counter pressure again builds in the control volume 9 and the valve flange 6.1 is again seated onto the valve seat 7.

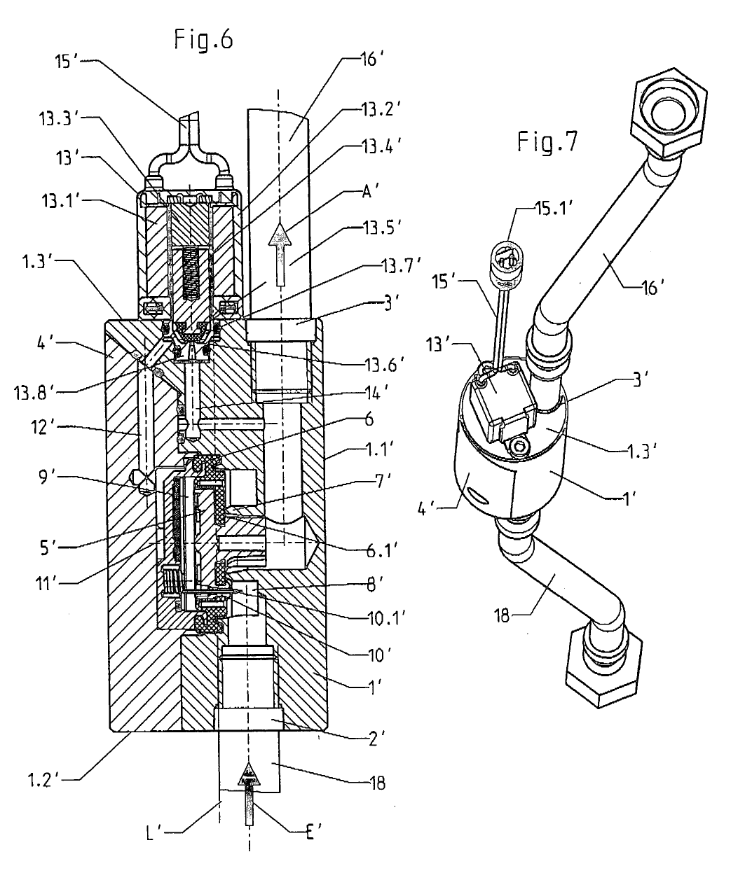

FIGS. 6 and 7 illustrate another embodiment of the inventive fluid control servo-solenoid valve with self-contained actuating fluid of the present invention which differs from the one embodiment of the inventive valve described with respect to FIGS. 1-5 only in the respect that the valve housing is, on the side thereof at which the valve inlet is located, not threadably secured in a valve receipt location but, instead, is connected via a pipe connection with an inlet or feed. Since the valve illustrated in FIG. 6 comprises the same features as the valve of the one embodiment illustrated in FIG. 1, the same corresponding components are denominated by the same reference numerals as shown in FIG. 1 with each reference numeral having, in FIGS. 6 and 7, the addition of a prime (′) symbol. Accordingly, these same corresponding components of the two embodiments of the inventive valve are not further described herein.

The side of the valve inlet 2′ of the embodiment of the valve shown in FIG. 6 is not provided with a threaded securement but comprises, instead, a pipe connection component to which a feed or inlet pipe 18 can be threadably secured. The housing cover 4′, which covers an opening permitting access into the interior volume of the housing, extends to the lower end surface 1.2′ of the housing.

FIG. 7 is an illustration of the another embodiment of the inventive valve shown in FIG. 6 and showing the connection thereof to the feed pipe 18 and an outflow pipe 16′.

The operation of the inventive valve illustrated in FIGS. 6 and 7 is the same as the operation of the inventive valve described with respect to FIGS. 1-5.

The specification incorporates by reference the disclosure of German priority document 202 19 358.6 filed Dec. 13, 2002.

The present invention is, of course, in no way restricted to the specific disclosure of the specification and drawings, but also encompasses any modifications within the scope of the appended claims.

What is claimed is:

1. A fluid control servo-solenoid valve with self-contained actuating fluid, in particular, for sanitary installations, wherein the fluid control servo-solenoid valve with self-contained actuating fluid includes a valve housing having therein a valve inlet and a valve outlet isolatable from one another in a sealed manner via the seating of a valve flange in a valve closing position on a valve seat, whereby the valve inlet and the valve outlet are located on two opposed sides of the valve housing, a displaceable differential piston, disposed in the valve housing, that supports thereon the valve flange, wherein, on one side of the differential piston, there is a pressure volume communicated with the valve inlet with the pressure volume being selectively communicable via the valve seat with the valve outlet while, on the other side of the differential piston, there is a control volume that is selectively communicable with the valve outlet via a relief bore that is closable by means of a closure element associated with the plunger of an electro-magnetic pilot valve, with the control volume being communicated via a control channel with the pressure volume and the pressure volume being sealed off relative to the control volume via a seal along the edge regions of the differential piston, wherein the servo-solenoid valve further comprises:
a) the housing being configured as a small, elongate body having a pair of lengthwise sides and a pair of widthwise sides each relatively shorter than either of the lengthwise sides, whereby the valve inlet and the valve outlet are each disposed on a respective one of the widthwise outer sides of the housing and the inlet/outlet flow direction E-A extends parallel to the housing longitudinal axis L;
b) the differential piston being disposed in the housing 1-such that its movement is perpendicular to the housing longitudinal axis L;
c) the pilot valve being dismountably secured on the respective widthwise outer side of the housing on which the valve outlet is located; and
d) the relief bore being configured as a pilot valve seat, closable by a closure element, and located between the valve chamber of the pilot valve and an outflow channel communicated with the valve outlet, whereby the valve chamber is communicated via a discharge channel with the control volume.

2. A fluid control servo-solenoid valve according to claim 1, wherein the housing is configured as a two-piece component having a base body supporting the valve inlet and the valve outlet, and including on one side an opening that provides access into the housing, the opening being covered by a housing cover extending in the direction of the housing longitudinal axis L over a portion of the longitudinal extent of the housing.

3. A fluid control servo-solenoid valve according to claim 2, wherein the differential piston as well as a hood covering the control volume are each components of a unitary component deployable into the housing interior via the opening in the housing.

4. A fluid control servo-solenoid valve according to claim 1, wherein the housing is configured as a cylinder with substantially planar, small widthwise end surfaces on its outer side.

5. A fluid control servo-solenoid valve according to claim 1, wherein at least one of the valve inlet and the valve outlet is provided with a respective pipe or hose communication element.

6. A fluid control servo-solenoid valve according to claim 1, wherein the respective one of the widthwise sides of the valve on which the valve inlet is located includes a threaded support through which the valve inlet extends, the threaded support serving for threaded securement of the valve in a valve receipt location.

7. A fluid control servo-solenoid valve with self-contained actuating fluid, in particular, for sanitary installations, wherein the fluid control servo-solenoid valve with self-contained actuating fluid includes a valve housing having therein a valve inlet and a valve outlet isolatable from one another in a sealed manner via the seating of a valve flange in a valve closing position on a valve seat, whereby the valve inlet and the valve outlet are located on two opposed sides of the valve housing, a displaceable differential piston, disposed in the valve housing, that supports thereon the valve flange, wherein, on one side of the differential piston, there is a pressure volume communicated with the valve inlet with the pressure volume being selectively communicable via the valve seat with the valve outlet while, on the other side of the differential piston, there is a control volume that is selectively communicable with the valve outlet via a relief bore that is closable by means of a closure element associated with the plunger of an electromagnetic pilot valve, with the control volume being communicated via a control channel with the pressure volume and the pressure volume being sealed off relative to the control volume via a seal along the edge regions of the differential piston, wherein the servo-solenoid valve further comprises:
a) the housing having a housing longitudinal axis L and being configured with the valve inlet and the valve outlet disposed on respective opposite sides such that the inlet/outlet flow direction E-A extends parallel to the housing longitudinal axis L;
b) the differential piston being disposed in the housing such that its movement is not parallel to the housing longitudinal axis L;
c) the pilot valve being secured on the respective outer side of the housing on which the valve outlet is located; and
d) the relief bore being configured as a pilot valve seat, closable by a closure element, and located between the valve chamber of the pilot valve and an outflow channel communicated with the valve outlet, whereby the valve chamber is communicated via a discharge channel with the control volume.

8. A fluid control servo-solenoid valve according to claim 7, wherein the housing is configured as a small, elongate body having a pair of lengthwise sides and a pair of widthwise sides each relatively shorter than either of the lengthwise sides, whereby the valve inlet and the valve outlet are each disposed on a respective one of the widthwise outer sides of the housing.

9. A fluid control servo-solenoid valve according to claim 7, wherein the differential piston is disposed in the housing such that its movement is perpendicular to the housing longitudinal axis L.

10. A fluid control servo-solenoid valve according to claim 7, wherein the pilot valve is dismountably secured on the respective widthwise outer side of the housing on which the valve outlet is located.
